(19) United States
(12) Patent Application Publication
(10) Pub. No.: US 2013/0210386 A1
(43) Pub. Date: Aug. 15, 2013

(54) Method And System For Routing Communications

(71) Applicants: George Perlin, Richmond Hill (CA); Alexandre Ioulich, Woodbridge (CA)

(72) Inventors: George Perlin, Richmond Hill (CA); Alexandre Ioulich, Woodbridge (CA)

(73) Assignee: POLAR WIRELESS CORPORATION, Richmond Hill (CA)

(21) Appl. No.: 13/703,716

(22) PCT Filed: Jun. 22, 2011
(86) PCT No.: PCT/CA11/50379

§ 371 Date: Jan. 28, 2013

Related U.S. Application Data
(60) Provisional application No. 61/357,825, filed on Jun. 23, 2010.

(51) Int. Cl. H04W 40/02

(52) U.S. Cl. CPC H04W 40/02
USPC 455/411; 455/414.1; 455/416

(57) ABSTRACT

A method for routing communications includes intercepting a request for communications service from a communications device, routing the intercepted request for service to an application server; and, executing the communications service being requested based on instructions from the application server.

### CROSS-REFERENCE TO RELATED APPLICATIONS

The application claims priority to U.S. Provisional Application No. 61/357,825 filed Jun. 23, 2010, the contents of which are herein expressly incorporated by reference.

### FIELD OF INVENTION

The present invention relates to the field of communications, and more particularly to mobile communications and a method and system for routing communications

### BACKGROUND OF THE INVENTION

Mobile telephone calls made when outside a user's home network generally incur roaming charges that can become extremely costly. Typical mobile telephones have a SIM (subscriber identity module) card used to identify the user and the base network to which the user belongs. Often times, user's attempting to avoid roaming charges will acquire secondary services directly from a foreign service provider, such as by purchasing a second SIM card and substituting the second SIM card for the primary one when in a roaming zone. This presents several problems, including the risk of losing the primary SIM card, the inconvenience of having two separate accounts and of having to carry two SIM cards around. Alternative solutions include providing special roaming access telephone numbers to route calls through service providers offering discounted rates, however this requires the user to dial extra digits prior to completing each telephone call and to remember these access numbers when travelling. Other users simply rely on calling cards which do save money for outgoing calls, but are not compatible or helpful with incoming calls. Indeed, a user has little or no control over incoming calls and the charges incurred when receiving a call in a roaming zone, other than to ignore the call altogether.

Similar problems are encountered with data communications and accessing internet services when in a roaming zone, particularly as smart phones become more widely used, particularly as a travel aid either for leisure and tourist travel or for business travelers. Data communications generally cannot be accessed at discounted roaming rates by way of special access roaming telephone numbers or by calling cards. Furthermore, it is often the case that a user may forget to turn data roaming off and unexpectedly incur significant charges as smart phone applications often access data in the background. While it is difficult to mitigate these problems in their entirety, providing access to other sources of data communication service providers or routing such communications via alternate intermediaries may be desirable. Similar prior art problems exist with SMS text messaging.

### SUMMARY OF THE INVENTION

According to one embodiment of the invention, there is provided a method for routing communications including intercepting a request for communications service from a communications device, routing the intercepted request for service to an application server, and, executing the communications service being requested based on instructions from the application server. According to one aspect of the invention, there is provided, before said executing step, authenticating the origin of the intercepted request. The communications may be any one of voice, data and SMS communications. Preferably, the communications device is a mobile device.

According to one aspect of the invention, the method includes providing an intercepting means for carrying out the intercepting step. Preferably, the intercepting means is a complimentary SIM card positioned between a SIM of said mobile device and an interface on said mobile device adapted to communicate with a SIM card.

According to another aspect of the invention, the step of routing the intercepted request to an application server includes routing the intercepted request to the application server via a mobile network operator in a geographical region of a user.

According to another aspect of the invention, the routing step includes sending a user data packet to the application server and the authentication step includes authenticating based on one or more data fields in said data packet. The one or more data fields is preferably selected from the group comprising a serial number, an International Mobile Subscriber Identity (IMSI) associated with the complimentary SIM, an MSISDN (Mobile Subscriber Integrated Services Digital Network Number) associated with the complimentary SIM, an MSISDN associated with the primary SIM, an associated DID (direct inward dialing) number, a VSIM profile identification, the called phone number, and the user's location.

According to another aspect of the invention, before the executing step, there is provided a step of authorizing the request for communications service, wherein the step of authorizing is carried out by the application server. Preferably, the authorizing step includes a step of determining whether the user has a sufficient account balance for at least a portion of the communications service being requested.

According to another aspect of the invention, the communications service is terminated by one of the application server, a mobile network operator and the user.

According to another aspect of the invention, the application server carries out the further steps of saving a record of communication details and sending a notification message to the means for intercepting with one or more details about the communication.

According to another aspect of the invention, the executing step comprises routing the communications service as a conference call between a recipient of the communications service, a roaming partner and a network operated by a provider of the application server. Preferably, the network operated by a provider of the application server is a VoIP network.

According to another aspect of the invention, the step of routing to the application server is initiated by sending an SMS message to the application server.

According to another embodiment of the invention, there is provided a system for routing communications including a means for intercepting a request for communications service from a communications device, a means for routing the intercepted request for service, an application server for receiving the intercepted request for service and, a means for executing the communications service being requested based on instructions from the application server. Optionally, the system further includes a means for authenticating the origin of the intercepted request. Preferably, the communications device is a mobile device.

According to one aspect of the invention, the means for authenticating comprises computer readable instructions provided on the application server.

According to another aspect of the invention, the intercepting means comprises a complimentary SIM card positioned between a SIM of the mobile device and an interface on the mobile device adapted to communicate with a SIM card.

According to another aspect of the invention, the means for routing sends a user data packet to said application server and the means for authenticating authenticates based on one or more data fields in the data packet. The one or more data fields is preferably selected from the group comprising a serial number, an International Mobile Subscriber Identity (IMSI) associated with the complimentary SIM, an MSISDN (Mobile Subscriber Integrated Services Digital Network Number) associated with the complimentary SIM, an MSISDN associated with the primary SIM, an associated DID (direct inward dialing) number, a VSIM profile identification, the called phone number, and the user's location.

According to another aspect of the invention, the application server further includes instructions thereon for authorizing said request for communications service.

According to another aspect of the invention, the instructions for authorizing include determining whether the user has a sufficient account balance for at least a portion of the communications service being requested and authorizing execution of the communication service if the user has a sufficient account balance.

According to another aspect of the invention, the system further includes a means for terminating said communications service.

According to another aspect of the invention, the application server saves a record of communication details and sends a notification message to said means for intercepting with one or more details about said communication.

It is an object of the invention to provide a solution to one or more of the herein-identified problems with the prior art. It is a further object of the invention to provide a new method and system for routing communications, and particularly for routing communications originating from or directed towards a mobile device.

Other and further advantages and features of the invention will be apparent to those skilled in the art from the following detailed description thereof, taken in conjunction with the accompanying drawings.

### BRIEF DESCRIPTION OF THE DRAWINGS

The invention will now be described in more detail, by way of example only, with reference to the accompanying drawings, in which like numbers refer to like elements, wherein:

FIG. 1 is a flow chart illustrating one embodiment of a method according to the invention.

FIG. 2 is a schematic representation of a computer system for carrying out aspects of the invention.

FIG. 3 is perspective view of a mobile device with a complimentary SIM according to one aspect of the invention.

FIG. 4 is a flow diagram showing one type of communication according to the invention.

FIG. 5 is a flow chart illustrating an authorization step shown in FIG. 1.

FIG. 6 is a flow diagram showing one call routing according to the invention.

FIG. 7 is a flow diagram illustrating a system according to one embodiment of the invention.

### DETAILED DESCRIPTION OF THE INVENTION

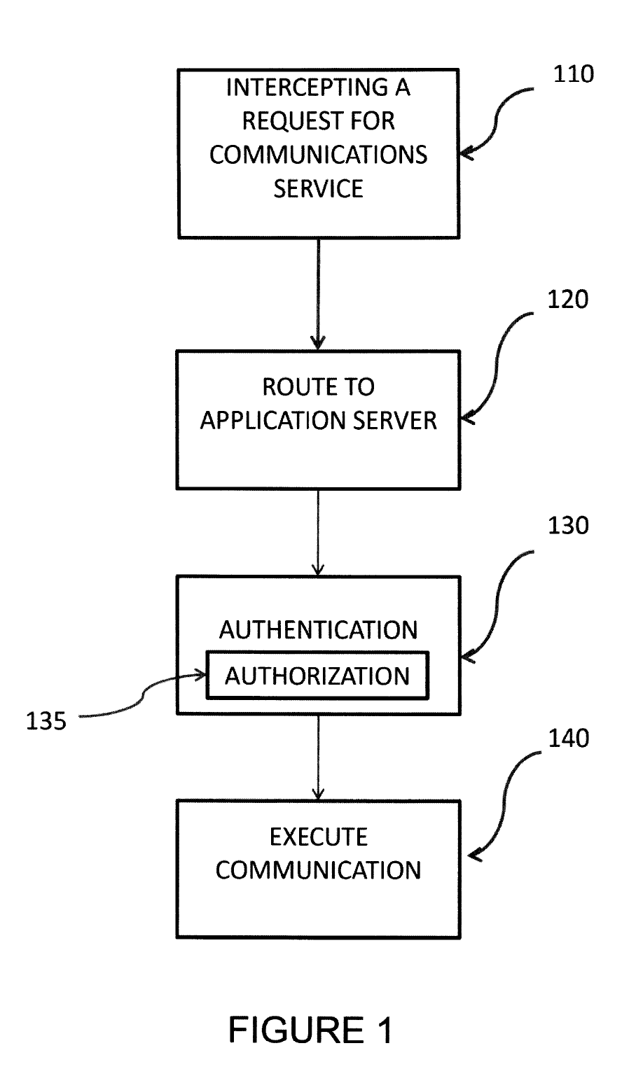

With reference to FIG. 1, according to one embodiment of the invention, there is provided a method for routing communications, and particularly communications involving at least one mobile device, including providing intercepting a request for communications service from a communications device 110 with an intercepting means, routing the intercepted request for service 120 to an application server, authenticating the origin of the intercepted request 130 and executing the communications service being requested 140 as directed by the application server. The communication is preferably carried out over a VoIP network maintained by the providers of the invention, or alternatively through the network of a roaming partner of the provider of the invention.

Various embodiments of the invention will be herein described for implementing the various steps of the method described above, as well as further preferred steps relating to different aspects of the invention. Throughout this description, reference is made to routing communications, executing communications and various other steps relating to communications. For the purposes of this application, communications relates to that made effective by telephones, mobile telephones, smart phones, tablet communication devices and various other devices that may operate using a SIM card. Specific modes of communication relevant to this invention include telephone calls, SMS messaging, multimedia messaging and data services. The invention is not limited to particular protocols of initiating and completing communications via these modes and any reference to particular protocols herein is strictly to facilitate understanding of the invention and to describe preferred embodiments for putting the invention into practice. Where reference in the preferred embodiments is made to mobile telephone calls, this reference may be equally applicable to messaging and data services and implementation of same for these services will be appreciated by those skilled in the art.

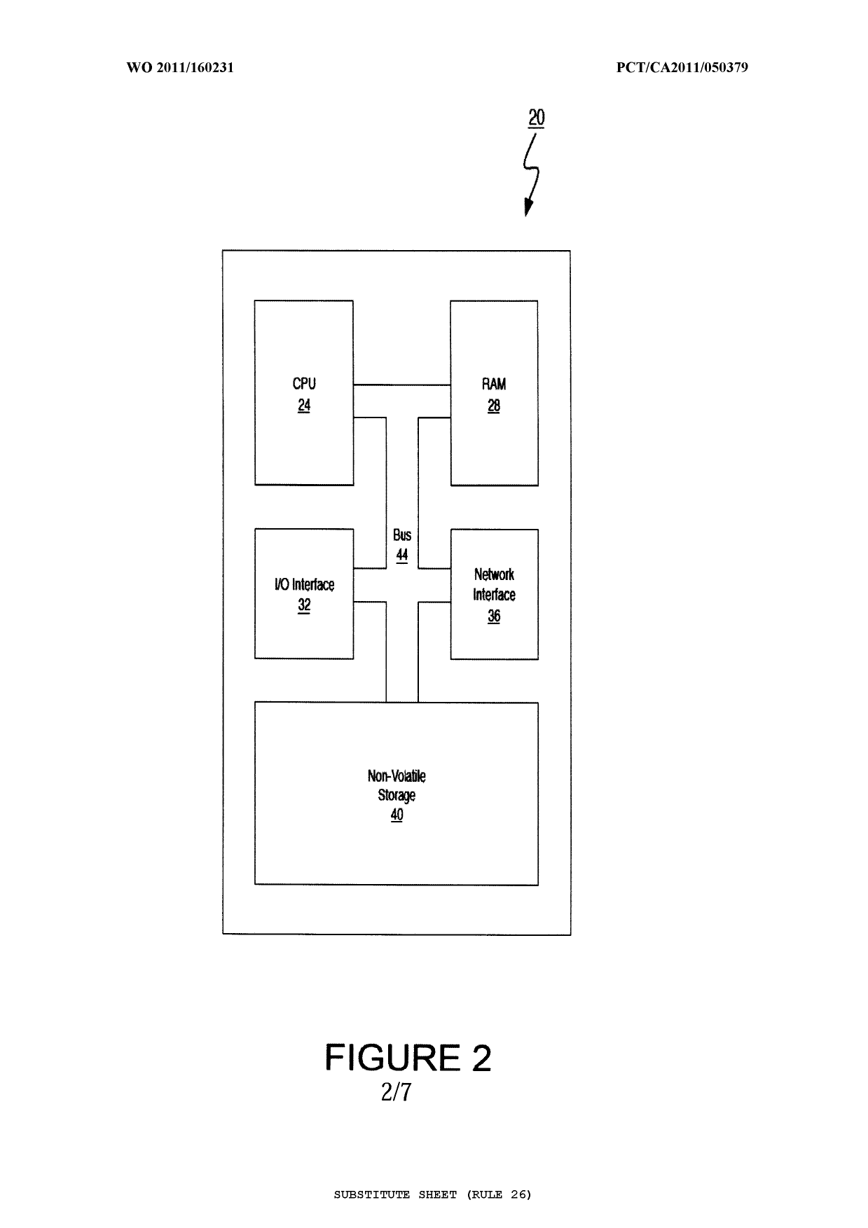

According to preferred embodiments, the invention relates to communications being initiated by a mobile communications device, such as a mobile telephone or smart phone. In particular, the invention relates to those mobile telephones or smart phones using SIM card technologies. Preferred embodiments of the means for intercepting a request for communications service will be described in more detail hereinbelow. The application server may be one or more computers acting in a capacity as a server and arranged to receive communications from the mobile device. A representative example is shown in FIG. 2 and includes a number of physical and logical components, including a central processing unit (“CPU”) 24, random access memory (“RAM”) 28, an input/output (“I/O”) interface 32, a network interface 36, non-volatile storage 4, and a local bus 44 enabling the CPU 24 to communicate with the other components. The CPU 24 executes an operating system, and a number of software systems and/or software modules. RAM 28 provides relatively-responsive volatile storage to the CPU 24. The I/O interface 32 allows for input to be received from one or more devices, such as a keyboard, a mouse, etc., and outputs information to output devices, such as a display and/or speakers. The network interface 36 permits communication with other elements of the invention described herein as being in networked communication with each other. Non-volatile storage 4 stores the operating system and programs. During operation of the computer system, the operating system, the programs and the data may be retrieved from the non-volatile storage 4 and placed in RAM 28 to facilitate execution.

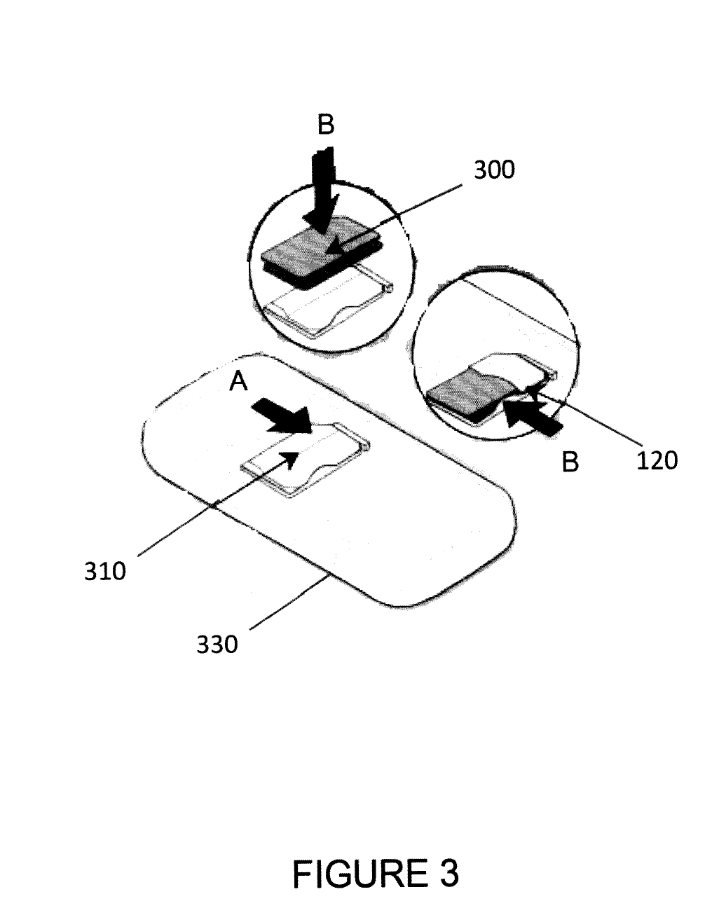

According to step 110 of FIG. 1, the invention includes providing a means for intercepting a request for communications service from a communications device. According to one embodiment of the invention, the request for communications service will be a request to initiate a telephone call on a mobile device, and particularly those mobile devices operating with a SIM card. As will be known by those skilled in the art, the majority of mobile devices in use today use SIM (subscriber identity module) cards to identify the user of the mobile phone and includes information on registration of the mobile device to the network of a particular network operator. Other network-specific information to identify the mobile device on the network are also stored on the SIM card, as would be known by those skilled in the art. The operation of such SIM cards is generally considered to be known and is not described in more detail herein. One example of a means for intercepting a request for communications service is the provision of a complimentary SIM card that fits into a mobile device and positioned between the SIM card native to the phone, hereinafter referred to also as the primary SIM card, and an interface between the mobile device and the primary SIM card. In this manner, a complimentary SIM card is positioned to provide a physical link between the primary SIM card and the interface on the mobile device that would otherwise have interacted with the primary SIM card. The complimentary SIM would be thin enough to fit into existing mobile devices between the primary SIM and the phone itself. Referring to FIG. 3, there is shown, schematically, a representative complimentary SIM 300 positioned between the primary SIM 310 and the mobile device 320. The complimentary SIM 300 may be kept in the phone indefinitely or may be easily removable. Broadly, the complimentary SIM 300 provides for an intermediary connection between the primary SIM and mobile device such that communications between the primary SIM and the mobile device can be intercepted. As shown, the primary SIM 310 may first be removed from the mobile device 330, at ‘A’, and the complimentary SIM inserted at a contact portion of the mobile device 330 at ‘B’. Finally, the primary SIM 310 is placed into contact with the complimentary SIM at ‘C’.

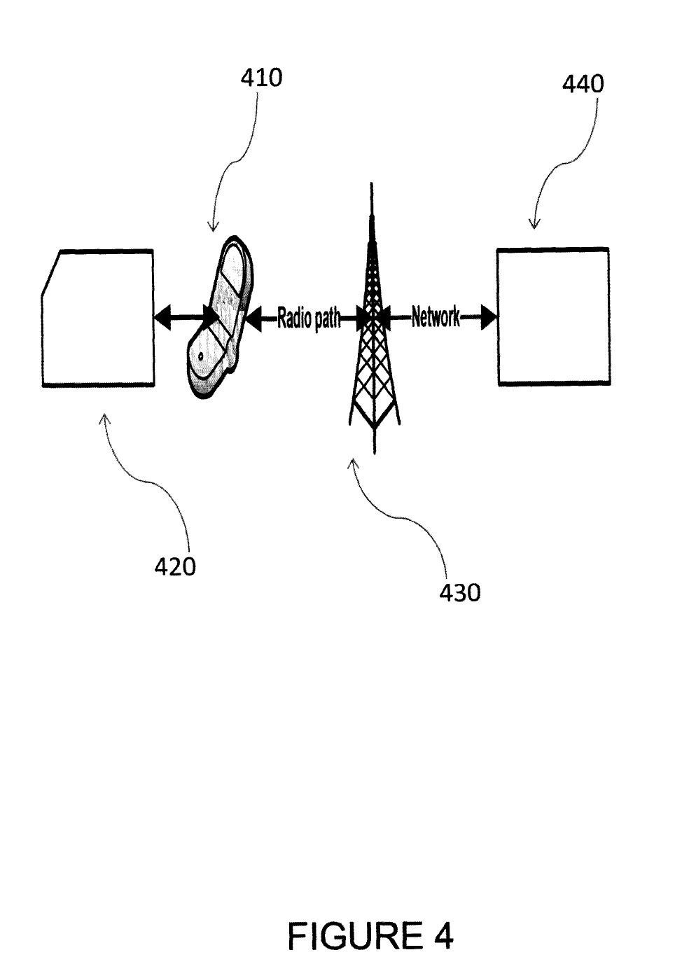

A request for communications service as referenced in step 110 of FIG. 1 occurs when a user places or receives a telephone call, sends or receives and SMS or attempts to access data services from a mobile device 410, as shown in FIG. 4. The user's requests are intercepted and routed by the complimentary SIM 420, via a mobile network operator 430 in the geographical region of where the user currently is, to an application server 440. The user's requests are routed to the application server 440 in a manner that depends on the service type originating the request, although these would typically be by the complimentary SIM sending SMS, USSD or HTTP messages to the application server.

The application server 440 undertakes an authentication step to confirm the identity of the user and to ensure that the user, and therefore the complementary SIM, are registered with the service provider of the invention. The routing of the request to the application server 440 may include a data packet that includes data including one or more selected from the following: a serial number, an International Mobile Subscriber Identity (IMSI) associated with the complimentary SIM, an MSISDN (Mobile Subscriber Integrated Services Digital Network Number) associated with the complimentary SIM, an MSISDN associated with the primary SIM, an associated DID (direct inward dialing) number, a VSIM profile identification, the called phone number, the user's location, and various other data that may be useful in identifying and determining the intended destination of the request for communications. Various other data would be applicable may be included in the data packet for other types of communications services being requested. Authentication of the user may be based on a user data packet, referred to above and may further include a server-side identification using one or more of the following records: a unique account identification number, a call flow scenario identification number, a customer account number, an associated DID number, the country code of the primary SIM, the mobile network code of the network operator of the primary SIM, the phone number associated with the user's device, a flag that indicates if the customer account is active, a flag that indicates if the customer account is a multi-user account, a code unique to the complimentary SIM, a serial number associated with the complimentary SIM, a phone number that belongs to the user's user profile, an MSISDN of the current virtual profile and a virtual SIM profile identification. Once the user has been authenticated as being a customer of the provider of the invention, the application server may proceed to providing authorization for the request for services. Alternatively, if the user cannot be authenticated, the session is terminated.

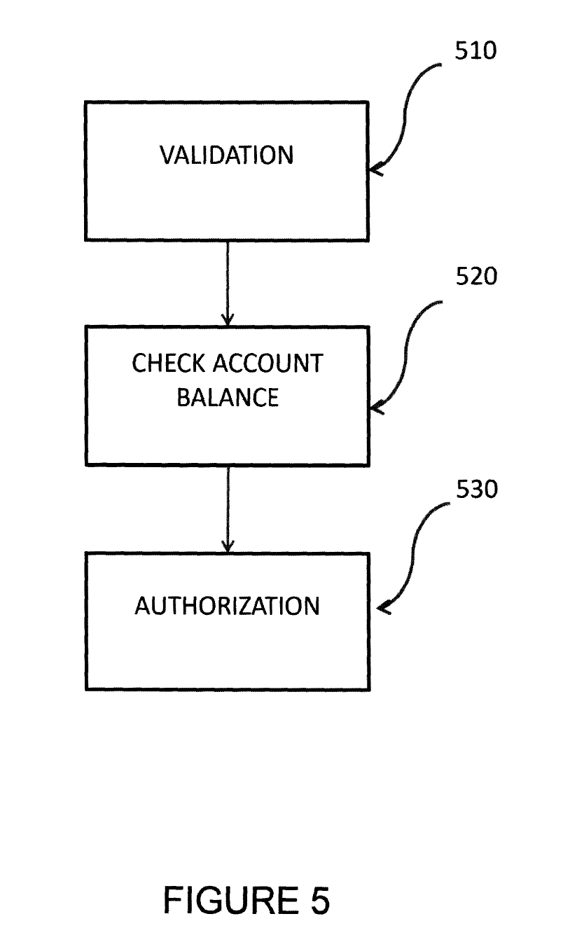

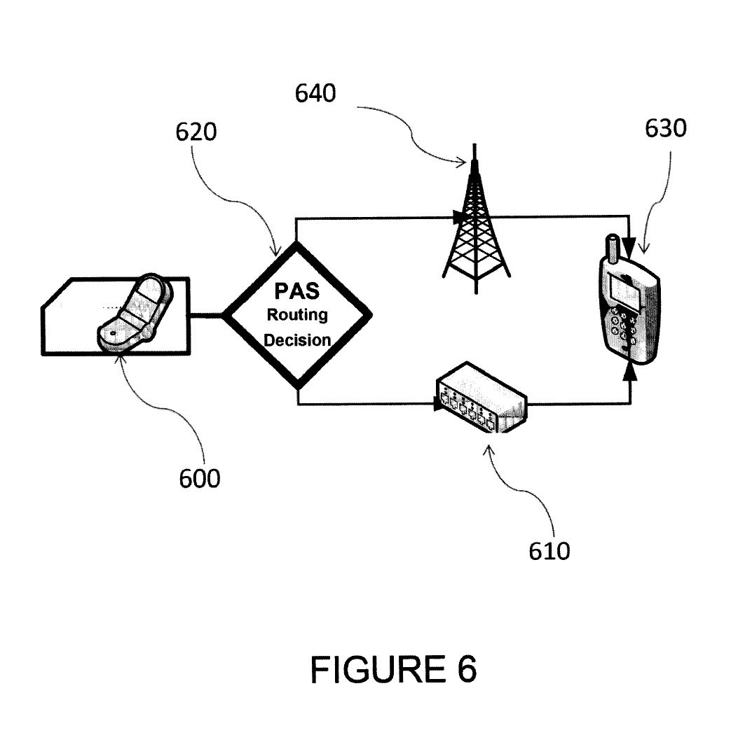

The optional authorization step 135 shown in FIG. 1 provides, for example, for a server-side check prior to completing the call that may confirm the ability of the user to pay for the communications service being requested. FIG. 5 shows a preferred embodiment of the authorization step. In step 510, validation of the call request is carried out, for example by checking the user's account type. Next, the application server authorizes the request for service against the account balance in step 520. The application server preferably determines the cost for the requested service per minute, checks the account balance and determines if the account balance is sufficient for at least one minute of service. If the account balance is less than the cost for one minute of service, then the application server terminates the session and optionally sends a note to the mobile device indicating the insufficiency of the funds. Finally, in step 530 the application server authorizes the request for service and confirms to the requestor, for example as shown in FIG. 6, in the case of a telephone call request from a phone 600, and the application server 620 sends a create conference request to a VoIP soft switch 610, for completing the call with a call receiver 630, and optionally via mobile network operator 640.

In step 140 of FIG. 1, the application server routes the request for communications service in a manner appropriate to complete the communication. Various possible ways of completing the communication are possible, depending on the type of communication being requested, where the communication is originating and the location of the user. Various embodiments of these implementations described further below.

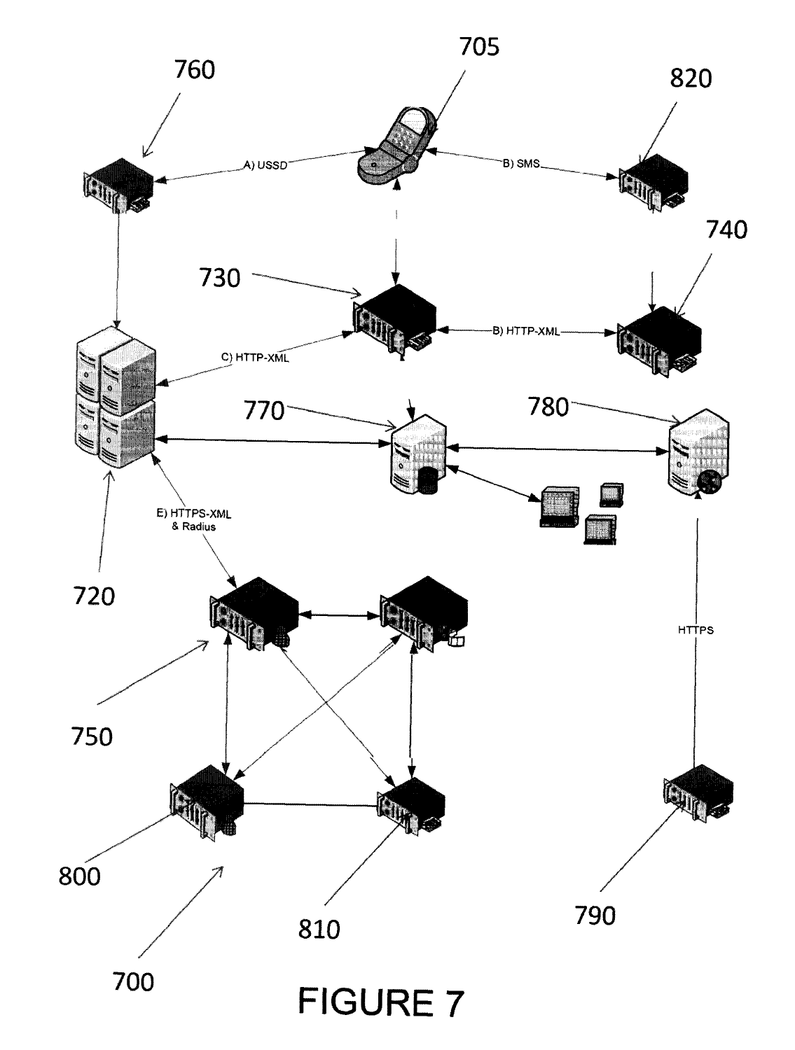

Referring now to FIG. 7, there is shown a top level view of the system 700 according to another embodiment of the invention. The system 700 is one possible system for implementing the method described above. An application server 720 is provided for handling all call requests from a mobile device 705, via a local network such as that run by a roaming partner 760, tracking call activity, and maintaining call data, for example for billing, in a central database. The application server 720 is preferably able to communicate directly with various mobile communications roaming partners 760. Communication with roaming partners 760 will be established by the service provider of the invention and rates for accessing the networks of roaming partners will be negotiated in advance and preferably will be rates favourable to the user. The roaming partners are those trusted network operators who have agreements in place with the operators of the invention to perform specialized roaming services. The operators of the invention will also maintain a database 770, in communication with the application server 720, third-party databases 780 and other cost centers 790 for interaction with difference service providers. The application server also accepts requests from a border controller 730 for messages coming from untrusted network operators and handles these requests accordingly. The border controller 730 may include a firewall to protect the application server from messages from untrusted sources, such as when operating under the GPRS protocol. In a preferred embodiment, the border controller 730 also acts as a message translator, creating a standard communications protocol for communications with the application server.

A message gateway 740 preferably handles SMS communication. If a selected message gateway 740 provides firewall capability, it would be allowed to communicate directly with the application server 720, if not, the message gateway is routed through the border controller 730. Typically, the message gateway 740 will be provided and run by a third party.

A VoIP switch 750 is provided to connect calls to outside phones, VoIP networks 800 and DID service providers 810. Optionally, a third party service manages the VoIP switch 750 and determines call routing and charging and is used to verify invoices from network operators. This third party may also store statistics about all calls in its database. The operation of VoIP networks and service providers are generally known in the art and therefore not described in further detail herein.

Having now described the hardware relevant to the invention, the software, interfaces, and relationships between the various hardware elements above will now be described in order to carry out the invention.

Preferably, an Internet web site is provided for customers using the invention to access online services including, but not limited to, making payments, refilling an account, viewing payment history, transferring credits, user profile updates, phone numbers, call blocks, subscriptions, speed dials, and various other telephone account management services as would be apparent to one skilled in the art.

In carrying out the invention, the complimentary SIM card sends SMS notifications to the application server 720 whenever the user enters roaming territory, or moves from one roaming zone to another, and further sends another SMS to the application server 720 when a call is initiated. Each of these SMS messages may travel through two intermediaries, an SMS aggregator 820 and the message gateway 740. Thus, there are three communications interfaces at this stage: (i) communication between the complimentary SIM and the SMS aggregator 820 requiring conversion between SMS and SMPP; (ii) communication between the SMS aggregator 820 and the message gateway 740 requiring conversion between SMPP and HTTP/XML; and, (iii) communication between the message gateway 740 and the application server 720. In one embodiment, the message gateway 740 may not communicate directly with the application server 720, but may first be directed through the border controller 730.

The complimentary SIM may further initiate calls over USSD to a roaming partner. The application server 720 requires an interface specification to carry out this communication. Interfaces of this type may be provided by various telecommunications companies, or directly from the roaming partners themselves.

The complimentary SIM may further initiate calls over GPRS to the border controller 730 and then on to the application server 720.

Having now described various aspects of the method and system according to the invention, a number of practical examples that would typically be encountered in use will now be described. As will be appreciated by those skilled in the art, these examples are representative of various embodiments of the description, but are not to be considered liming on the invention.

### Example I

A user is located in their native (i.e. non-roaming) zone and initiates a long distance telephone call. The complimentary SIM intercepts the request for service and sends an SMS to the application server. The application server authenticates the user's identity, checks their account balance, and authorizes or rejects the request. When the long distance call is executed, the application server starts counting the service time. The call can be terminated by any of the following parties: caller, receiver, mobile network provider, or the application server. When the call is terminated, the application server deletes the session, saves the call details record and sends a notification message to the complimentary SIM with the following information: call duration, call price and optionally, amount saved.

### Example II

A user is in a roaming zone, and outside of the user's home country. The VSIM (virtual SIM) profile on the complimentary SIM card is thus active. The complimentary SIM intercepts the request for service and sends a USSD message to the application server. The application server authenticates the user's identity, determines their location and the availability of a roaming partner, checks the account balance, and authorizes or rejects the request for service. One of three scenarios can then be selected by the application server depending on the location of the user, the most cost effective approach and availability of particular roaming partners. In the first scenario, both parties in the call—the caller and the receiver—are handled by the roaming partner. Thus, after authorization the communication will be put through a selected roaming partner's gateway. In the second scenario, the caller is handled by the roaming partner and the call receiver is handled by gateway of the service provider of the invention. Finally, in the third scenario, both the caller and the receiver are handled by the gateway of the service provider of the invention.

In executing the call based on the first scenario, the application server sends an authentication response to the roaming partner. the roaming partner originates a call to the caller, waits until the call is connected and sends a call-in-progress message to the application server which starts the accounting session for the caller. The roaming partner initiates a call to the receiver, waits until the call is connected and sends a call-in-progress message to the application server which starts the accounting session for the receiver.

In executing the call based on the second scenario, the application server sends an authentication response to the roaming partner. The roaming partner waits until the call is connected and sends a call-progress message to the application server. The application server starts the accounting session for the caller. The roaming partner originates a call to the receiver via a its gateway, such as an IMG SS7-SIP Gateway, which is routed to the service provider of the invention and waits until the call is connected and sends a call-progress message to the application server.

In executing the call based on the third scenario, the application server sends an authentication response to the roaming partner with routing information. The roaming partner requests a Mobile Station Roaming Number from the roaming network. The roaming partner then originates a call to the caller via its gateway, waits until the call is connected and sends a call-progress message to the application server. The application server starts the accounting session for the caller. The roaming partner originates a call to the receiver via its gateway, waits until the call is connected and sends a call-progress message to the application server. The application server then stars the accounting session for the receiver. In both these cases, the gateway referred to may be a IMG SS7-SIP Gateway which is routed to a network operated by the service providers of the invention.

In this example, once service is authorized, and the selected by scenario gateway corresponds with the caller, after which the caller replies and the call will be placed to the receiver. After the receiver replies, the communication is established and the application server starts counting the service time. The call can be terminated by any of the parties involved in the call, that is, by the caller, the receiver, the network, the application server or the roaming partner. When the call is terminated, the application server deletes the session, saves the call detail record and sends a notification message to the complimentary SIM with information relating to the call duration, call price, and optionally the amount saved.

### Example III

In this example, a direct call is initiated when the user in a roaming partner zone. In this case, the complimentary SIM does not intercept the request for service. The call request is sent directly to the roaming partner who sends the request to the application server. The application server authenticates the user's identity, determines their location and after checking the account balance, the application server authorizes or rejects the request for service put through it by the roaming partner's gateway. When the service is placed, the application server starts counting the service time, The call can be terminated by any of the parties involved in carrying out the call. When the call is terminated, the application server deletes the session, saves the call details record and sends a notification to the complimentary SIM with information relating to the call duration, call price and optionally, amount saved.

### Example IV

In this example, a call is forwarded via the Direct Inward Dialing (DID) service of the providers of the invention while the user in a roaming zone. All incoming calls received to the user's home number will be forwarded to the user's mobile phone through the DID number and serviced as outlined below. A VoIP gateway of the provider's of the invention receives a request for communication with a user having a complimentary SIM. The gateway sends the request for service to the application server and after successful authorization, places a call to the complimentary SIM via the roaming partner's gateway. The call can be terminated by any of the parties involved, as in the prior examples. When the call is terminated, the application server deletes the session, saves the call details record and sends a notification message to the complimentary SIM with call complete details.

### Example V

In this example, the complimentary SIM user is in a roaming zone and the application server makes a decision to route the call via a network operated by the provider's of the invention. This decision is based on cost effectiveness or the availability of the route. The roaming partner receives a call for the user's VSIM MSISDN number and sends the request for authorization to the application server. When the request is authorized, the application server makes the routing decision and responds to the roaming partner.

This concludes the description of the presently preferred embodiments of the invention. The foregoing description has been presented for the purpose of illustration and is not intended to be exhaustive or to limit the invention to the precise form disclosed.

1. A method for routing mobile device communications comprising:
intercepting a request for communications service from a mobile device by providing an intercepting means, wherein said intercepting means comprises a complimentary SIM card positioned between a SIM of the mobile device and an interface on the mobile device adapted to communicate with a SIM card;
routing the intercepted request for service to an application server; and,
executing the communications service being requested based on instructions from the application server.

2. A method for routing communications according to claim 1 further comprising, before said executing step, authenticating the mobile device.

3. (canceled)

4. A method for routing communications according to claim 1, wherein said step of routing the intercepted request to an application server includes routing the intercepted request to an application server via a mobile network operator in a geographical region of a user.

5. A method for routing communications according to claim 2, wherein said routing step includes sending a user data packet to said application server and said authentication step comprises authenticating based on one or more data fields in said data packet.

6. A method for routing communications according to claim 5, wherein said one or more data fields is selected from the group comprising a serial number, an International Mobile Subscriber Identity (IMSI) associated with the complimentary SIM, an MSISDN (Mobile Subscriber Integrated Services Digital Network Number) associated with the complimentary SIM, an MSISDN associated with the SIM, an associated DID (direct inward dialing) number, a VSIM profile identification, a called phone number, and a user's location.

7. A method for routing communications according to claim 1, further comprising, before said executing step, a step of authorizing said request for communications service, wherein said step of authorizing is carried out by said application server.

8. A method for routing communications according to claim 7, wherein said authorizing step comprises a step of determining whether a user has a sufficient account balance for at least a portion of the communications service being requested.

9. A method for routing communications according to claim 1 further comprising the step of terminating the communications service.

10. A method for routing communications according to claim 9 further comprising the steps, carried out by said application server of, saving a record of communication details and sending a notification message to said means for intercepting with one or more details about said communication.

11. A method for routing communications according to claim 1, wherein said executing step comprises routing said communications service as a conference call between a recipient of said communications service, a roaming partner and a network operated by a provider of said application server.

12. A method for routing communications according to claim 11, wherein said network operated by a provider of said application server is a VoIP network.

13. A method for routing communications according to claim 1, where said step of routing to said application server is initiated by sending an SMS message to said application server.

14. A system for routing mobile device communications comprising:
a means for intercepting a request for communications service from a mobile device;
a means for routing the intercepted request for service;
an application server for receiving said intercepted request for service; and,
a means for executing the communications service being requested based on instructions from the application server;
wherein said intercepting means comprises a complimentary SIM card positioned between a SIM of said mobile device and an interface on said mobile device adapted to communicate with a SIM card.

15. A system for routing communications according to claim 14, further comprising a means for authenticating the mobile device; wherein said means for authenticating comprises computer readable instructions provided on said application server.

16. (canceled)

17. A system for routing communications according to claim 14, wherein said means for routing routes the intercepted request to said application server via a mobile network operator in a geographical region of a user.

18. A system for routing communications according to claim 15, wherein said means for routing sends a user data packet to said application server and said means for authenticating authenticates based on one or more data fields in said data packet.

19. A system for routing communications according to claim 18, wherein said one or more data fields is selected from the group comprising a serial number, an International Mobile Subscriber Identity (IMSI) associated with the complimentary SIM, an MSISDN (Mobile Subscriber Integrated Services Digital Network Number) associated with the complimentary SIM, an MSISDN associated with the primary SIM, an associated DID (direct inward dialing) number, a VSIM profile identification, a called phone number, and a user's location.

20. A system for routing communications according to claim 14, wherein said application server further includes instructions thereon for authorizing said request for communications service; wherein said instructions for authorizing include determining whether the user has a sufficient account balance for at least a portion of the communications service being requested and authorizing execution of the communication service if a user has a sufficient account balance.

21. (canceled)

22. A system for routing communications according claim 14, further comprising a means for terminating said communications service.

23. A system for routing communications according to claim 22, wherein said application server saves a record of communication details and sends a notification message to said means for intercepting with one or more details about said communication.
